(19) United States
(12) Patent Application Publication
(10) Pub. No.: US 2014/0136260 A1
(43) Pub. Date: May 15, 2014

(54) SYSTEM AND METHOD FOR OPERATIONAL QUALITY AWARE STAFFING REQUIREMENTS IN SERVICE SYSTEMS

(71) Applicant: INTERNATIONAL BUSINESS MACHINES CORPORATION, Armonk, NY (US)

(72) Inventors: Gargi B. Dasgupta, Gurgaon (IN); Nirmit V. Desai, Bangalore (IN); Jayan Nallacherry, Bangalore (IN); Yedendra B. Shrinivasan, Bangalore (IN)

(73) Assignee: International Business Machines Corporation, Armonk, NY (US)

(21) Appl. No.: 13/672,930

(22) Filed: Nov. 9, 2012

(51) Int. Cl. G06Q 10/06

(52) U.S. Cl. CPC G06Q 10/063118
USPC 705/7.17

(57) ABSTRACT

A system and method of determining operational quality aware staffing requirements in service delivery systems. Optimum staffing requirements are determined by workload based simulation and optimization. Operational quality metrics are periodically measured against benchmarks to determine quality scores based upon the level of performance. The staffing requirements and quality scores are used to perform a population distribution and correlation analysis to devise an operational quality to staffing relationship.

### BACKGROUND OF THE INVENTION

1. Field of the Invention

The present invention relates to Service System and, more particularly, to a system and method for determining staffing requirement of a Service Delivery System.

2. Background and Related Art

Service Delivery Systems (SDS) are most often labor intensive and the cost of service delivery highly dependent upon people assets. The cost of people assets in a human provided service is the majority of the overall cost of delivery of the service. However, optimizing labor costs alone may lead to suboptimal performance over the long term. As a result, quality improvement initiatives have been introduced into such systems in an attempt to consider long term quality.

Typical present day staffing methods and systems are primarily workload based. One of the difficulties with workload based focus is that it tends to sacrifice quality. For example, if SDS “A” and “B” both have essentially the same work volumes for their respective customers and “A” is not spending time on quality improvement efforts and “B” is spending a significant amount of time on quality improvement efforts, then the staffing requirement for SDS “B” would be higher than that of SDS “A”. This may result in SDS “A” being found to be overstaffed whereupon staff may be reduced notwithstanding that quality is not being addressed by SDS “A”.

Compliance with Service Delivery Frameworks (SDF) that drive predictable delivery outcomes and enable Continuous Improvements (CI) are essential to long term overall quality of services delivered and, thus, the on-going cost of delivery of the services. For example, a SDF may contain a Defect Prevention Process requiring technical staff to undertake Root Cause Analysis (RCA) on defects that are repeated in nature, and take necessary proactive actions to reduce such defects from the IT infrastructure. Failure to undertake such RCA investigations result in defect volume continuing to increase necessitating additional staff to handle the increased volume of defects.

### SUMMARY OF THE PRESENT INVENTION

Accordingly, methods and systems that work to optimize staffing are essential to both quality of service and profit margins. Such systems need to be able to balance labor costs and quality. To balance labor costs and quality requires an understanding of the interrelationship of quality and cost.

In accordance with embodiments of the present in invention, a SDF simulator is used in a simulation process to identify effective staffing levels of an SDS based on workload. In addition, operational quality is analyzed by measuring the level of compliance the SDS has with quality initiatives of the SDF, and the data from the above processes is used to identify Operational Quality aware SDS staffing recommendations.

In accordance with embodiment of the invention, a method for determining operational quality aware staffing requirements in service delivery systems, comprising: running a simulation over time of service delivery system service calls from multiple customers to determine performance results against the service level agreement and optimizing staffing levels while satisfying the service level agreement of the service delivery system; periodically measuring operational quality metrics against benchmarks in the service delivery system as taken over multiple periods of time to determine quality scores based upon the level of operational performance of the service delivery system related to each metric of said operational quality metrics; computing the threshold of acceptable quality score for each metric of the service delivery systems from the measurements taken in all service delivery systems; setting quality scores above the threshold as one of either a good quality score or a bad quality score and quality scores below the threshold as the other; computing overstaffing as the difference between the actual current staffing level and the optimal staffing level of a service delivery system so that when overstaffing is negative the service delivery system is other-staffed and needs more staffing and when overstaffing is positive the service delivery system has more staff than it needs; and computing the likelihood for each average operational quality metric of said operational metrics with respect to staffing in a population distribution analysis.

In accordance with embodiments of the invention, a method of determining operational quality aware staffing requirement in service delivery systems, comprising: running a simulation over time of service delivery system service calls from multiple customers to determine performance results against the service level agreement and optimizing staffing levels while satisfying the service level agreement of the service delivery system; periodically measuring the operational quality metrics against benchmarks in the service delivery system as taken over multiple periods of time to determine a quality score based upon the level of operational performance of the service delivery system related to each of the operational quality metrics; computing the average quality score for each metric from the measurements taken in all the service delivery system of the service delivery organization; setting average quality score for each metric as a threshold; setting quality scores above average as a bad quality score and quality scores below average as a good quality score; computing the degree of overstaffing as the difference between actual current staffing and the optimal staffing of a service delivery system so that when Overstaffing is negative the service delivery system requires additional staff and when Overstaffing is positive the service delivery system has more staff than it needs; and computing likelihood of a service delivery system being overstaffed vis-à-vis the quality scores of the various operational metrics in the service delivery system based on staffing and operational quality scores data from all service deliver systems in the service delivery organization.

In accordance with embodiments of the invention, a computer program product for determining operational quality aware staffing requirements in service delivery systems, said computer program product comprising: a computer readable storage medium; first program instructions for running a simulation over time of service delivery system service calls from multiple customers to determine performance results against the service level agreement and optimizing staffing levels while satisfying the service level agreement of the service delivery system; second program instructions for periodically measuring operational quality metrics related to a service outcome of staffing against benchmarks in the service delivery system as taken over multiple periods of time to determine quality scores based upon the level of operational performance of the service delivery system related to each metric of said operational quality metrics; third program instructions for computing the threshold of acceptable quality score for each metric of the service delivery systems from the measurements periodically taken over multiple periods of time from all service delivery systems; fourth program instructions for setting the quality scores above the threshold as one of either a good quality score a bad quality score and quality scores below the threshold as the other; fifth program instructions for computing overstaffing as the difference between the actual current staffing level and the optimal staffing level of a service delivery system so that when overstaffing is negative the service delivery system is other-staffed and needs additional staffing and when Overstaffing is positive the service delivery system has more staff than it needs; sixth program instructions for computing the likelihood data for each average operational quality metric of said operational metrics with respect to staffing in a population distribution analysis; and wherein said first, second, third, fourth, fifth and sixth program instructions are stored on said computer readable storage medium.

In accordance with embodiments of the present invention, a system for determining operational quality aware staffing requirements in service delivery systems, comprising: a simulation module for running a simulation over time of service delivery system service calls from multiple customers to determine performance results against the service level agreement and optimizing staffing levels while satisfying the service level agreement of the service delivery system; a measuring module periodically measuring operational quality metrics against benchmarks in the service delivery system as taken over multiple periods of time to determine quality scores based upon the level of operational performance of the service delivery system related to each metric of said operational quality metrics; an operational quality to staffing relationship analyzer for; computing the acceptable threshold quality score for each metric of the service delivery system from the measurements periodically taken over multiple periods of time from multiple service delivery systems; setting the quality scores above the threshold as one of either a good quality score or bad quality score and quality scores below the threshold as the other; computing overstaffing as the difference between the actual current staffing level and the optimal staffing level of a service delivery system so that when overstaffing is negative the service delivery system is other-staffed and needs additional staff and when overstaffing is positive the service delivery system has more staff than needed; and computing likelihood data for each average operational quality metric of said operational metrics with respect to staffing in a population distribution analysis.

### BRIEF DESCRIPTION OF THE DRAWING

The present invention is illustrated by way of example, and not by way of limitation, in the figures of the accompanying drawings and in which;

FIG. 1 is an exemplary overall system view in which embodiments of the present invention may operate.

FIG. 2 shows a further depiction of a system wherein the various pieces of data and code files used in embodiments of the present invention are identified in system memory/storage arrangement.

FIG. 3 shows an overall process/system view of one embodiment for carrying out operational quality aware staffing requirements in service systems.

FIG. 4 shows process/system view of one embodiment for workload based simulation.

FIG. 5 shows a flow chart for optimizing staffing levels using the workload based simulation of FIG. 4.

FIG. 6 shows a process/system view of one embodiment for measuring operation quality.

FIG. 7 shows a flow chart for measuring and assigning values to operational quality.

FIG. 8 shows a flow diagram for the operation of the Operational Quality to Staffing Relationship Analyzer of FIG. 3.

FIG. 9 shows a Population Distribution Chart as part of the output from the Operational Quality to Staffing Relationship Analyzer.

FIG. 10 shows a Correlation Analysis Chart as part of the output from the Operational Quality to Staffing Relationship Analyzer.

FIG. 11 shows a relationship graph as part of the output from the Operational Quality to Staffing Relationship Analyzer.

FIG. 12 shows a flow diagram for the operation of the Operational Quality Aware Staffing SDS Recommender of FIG. 3.

FIG. 13 shows an interactive user interface to the processes of the Operational Quality Aware Staffing Requirements system.

### DETAILED DESCRIPTION OF THE DRAWINGS

As will be appreciated by one skilled in the art, aspects of the present invention may be embodied in any of a variety of ways, some of which will be described herein as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (EPROM) or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. Portions of the program code may execute on the user's computer or terminal, and portions on intermediate and/or remote computers or servers. The remote computers may be connected to the intermediate and/or user's computer or terminal through any type of network, including a local area network (LAN) or a wide area network (WAN), or the connection may be made to an external computer (for example, through the Internet using an Internet Service Provider).

Aspects of the present invention are described below with reference to system and flowchart illustrations and/or block diagrams of methods, apparatus (systems) and computer program products according to embodiments of the invention. It will be understood that each block of the flowchart illustration, and combinations of blocks in the flowchart illustrations, can be implemented by computer program instructions. These computer program instructions may be provided to a processor of a general purpose computer, special purpose computer, or other programmable data processing apparatus to produce a machine or system, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or system, other programmable data processing apparatus, or other devices, such as, storage devices, user terminals, or remote computers such as, servers, to function in a particular manner, such that the instructions stored in the computer readable medium produce an article of manufacture including instructions which implement the function/act specified in the flowchart and/or block diagram block or blocks.

The computer program instructions may also be loaded onto a computer or system, other programmable data processing apparatus, or other devices, such as, storage devices, user terminals, or remote computers such as servers, to cause a series of operational steps to be performed on the computer, computer system arrangement and/or other programmable apparatus or other devices to produce a computer implemented process such that the instructions which execute on the computer, computer system arrangement and/or other programmable apparatus provide processes for implementing the functions/acts specified in the flowchart and/or block diagram block or blocks.

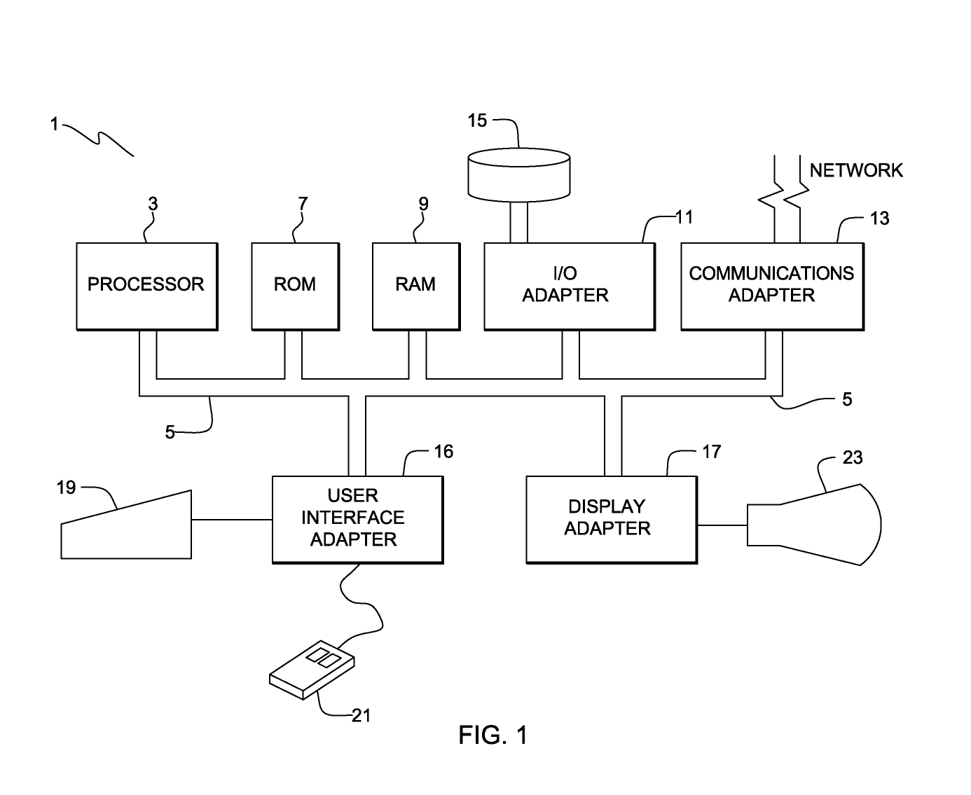

With reference to FIG. 1, there is shown an overall data processing system 1 in which embodiments of the present invention may operate. A processor 3 is shown coupled to other components by bus 5 and includes a basic input/output system (BIOS) that controls the basic functions of data processing system 1. Random Access Memory (RAM) 9, I/O adapter 11 and Communications Adapter 13 are also coupled to the system bus 5. I/O adapter 11 may also be a small computer system interface (SCSI) adapter that communicates with other devices, such as, with disk storage device 15. Communications Adapter 13 also interconnects bus 5 to a network, such as a local area network (LAN) or a Wide Area Network (WAN) which allows the data processing system to communicate with other systems and devices.

Input/output devices are also connected to system bus 5 via User Interface Adapter 16 and Display Adapter 17. In this manner, a user is capable of inputting to the system via keyboard 19 or mouse 21 and receiving output from the system via display device 23. It is clear that other devices may be used to input information such as a Personal Computer, scanner and the like.

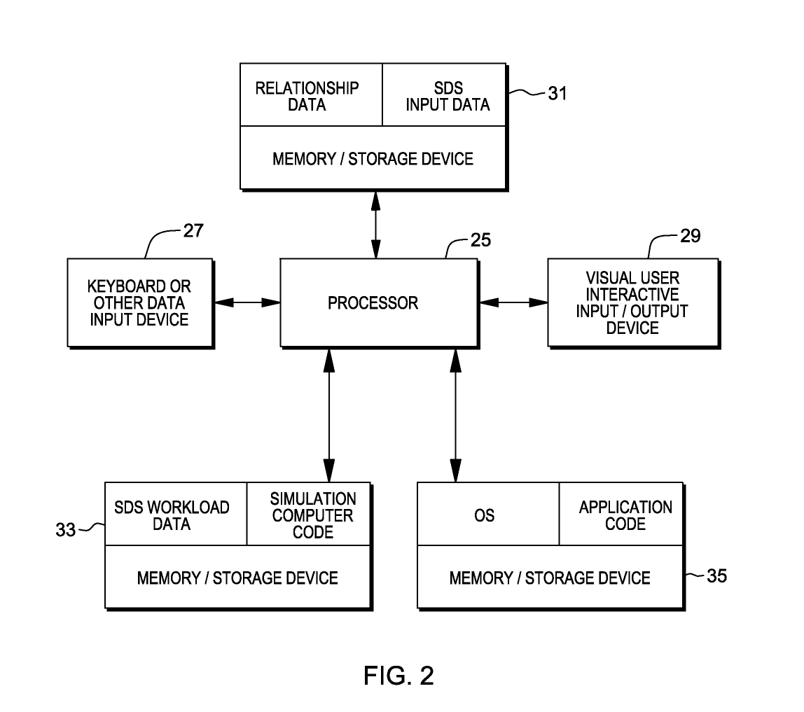

Implementation of the invention includes implementations as a computer system programmed to execute the method or methods described herein, and as a computer program product. According to the computer system implementation, sets of instructions for executing the method or methods may be resident in the ROM 7 or RAM 9, as shown in FIG. 1 or as variously shown in the memory arrangements of FIG. 2. Such instructions may be on one or more computer systems configured generally as described above. Until required by the computer system, the set of instructions may be stored as a computer program product in another computer memory, for example, in a disk drive (which may include a removable memory such as an optical disk or floppy disk for eventual use in the disk drive). Further, the computer program product can also be stored at another computer and transmitted when desired to the user's work station by a network or by an external network such as the Internet. One skilled in the art would appreciate that the physical storage of the sets of instructions physically changes medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that invention may describe terms such as comparing, analyzing, validating, selecting, identifying, or other terms that could be associated with a human operator. However, for operations described herein which form major part of the embodiments, no action by a human operator is present. The operations described are, in large part, machine operations processing electrical signals to generate other electrical signals.

FIG. 2 shows a further representation of computer system hardware wherein various forms of data and program code used in accordance with embodiments of the present invention are shown stored in Memory/Storage Devices connected to Processor 25. The Memory/Storage Devices shown in FIG. 2 may be RAM or ROM or both. Data is entered via Keyboard or Other Data Input Device 27 and may be viewed and also entered or modified via Visual User Interactive Input/output Device 29.

With further reference to FIG. 2, Service Delivery Systems (SDS) Input Data and SDQ and Staffing Relationship Data is shown in Memory/Storage Device 31. SDS Work Load Data and Simulation Code as employed in embodiments of the present invention is shown stored in Memory/Storage Device 33. Application Code and Operating System (OS) Code is shown stored in Memory/Storage Device 35.

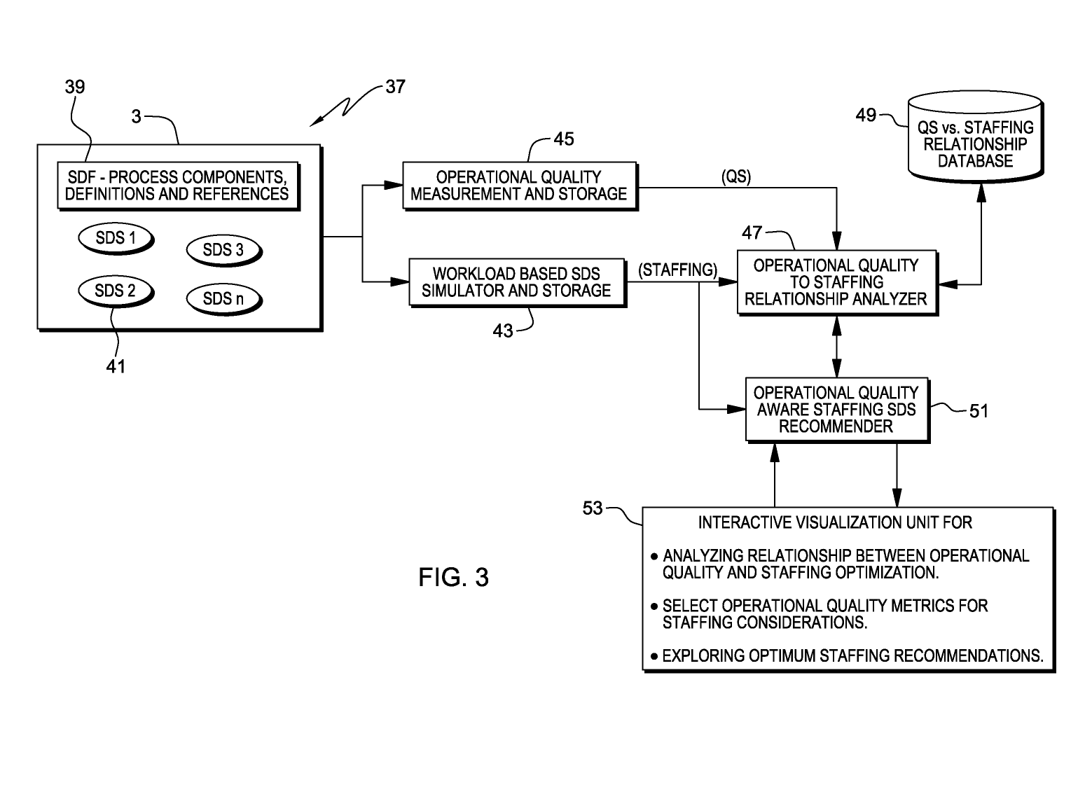

FIG. 3 shows an overall Process Operations/Systems view of an embodiment in accordance with the invention. Input to the process is shown in block 37. Service Delivery Framework (SDF) 39 includes a set of standard delivery practices and processes components, definitions and references. The SDF is a common repository where the SDF components are defined, described in detail and serves as the master repository of process framework for all Service Delivery Systems (SDS) pools of resources (SDS1 . . . SDSn) to follow. The SDF ensures predictable delivery outcomes for SDSs to follow and enables Continued Improvements (CI) to the SDSs. Non-compliance to the framework components can create adverse impact on delivery outcomes, and result in service quality and productivity of the SDSs being unpredictable. In this regard, the SDF also includes a Defect Prevention Process component whereby Root Cause Analysis on the defects that are repeated in nature allow corrective action to reduce the defects.

The SDF also includes multiple tools and databases used to track information related to the various SDS pools, such as, demography, work load details (e.g. ticket data), Service Level Agreement (SLA) information, a time and effort tracking tool, a defect prevention tracking tool, a security and system currency tool, human resource databases, and the like. The tools act to provide the operational data of the SDSs.

SDS1 . . . SDSn pools, shown at 41 in FIG. 3, include available resources grouped together based upon skills and capabilities for serving multiple customers in which resources are called upon in accordance with the delivery practices and processes defined in the SDF. It also includes, in accordance with embodiments of the present invention, a set of SDS operational metrics against which performance of the SDS operations may be measured.

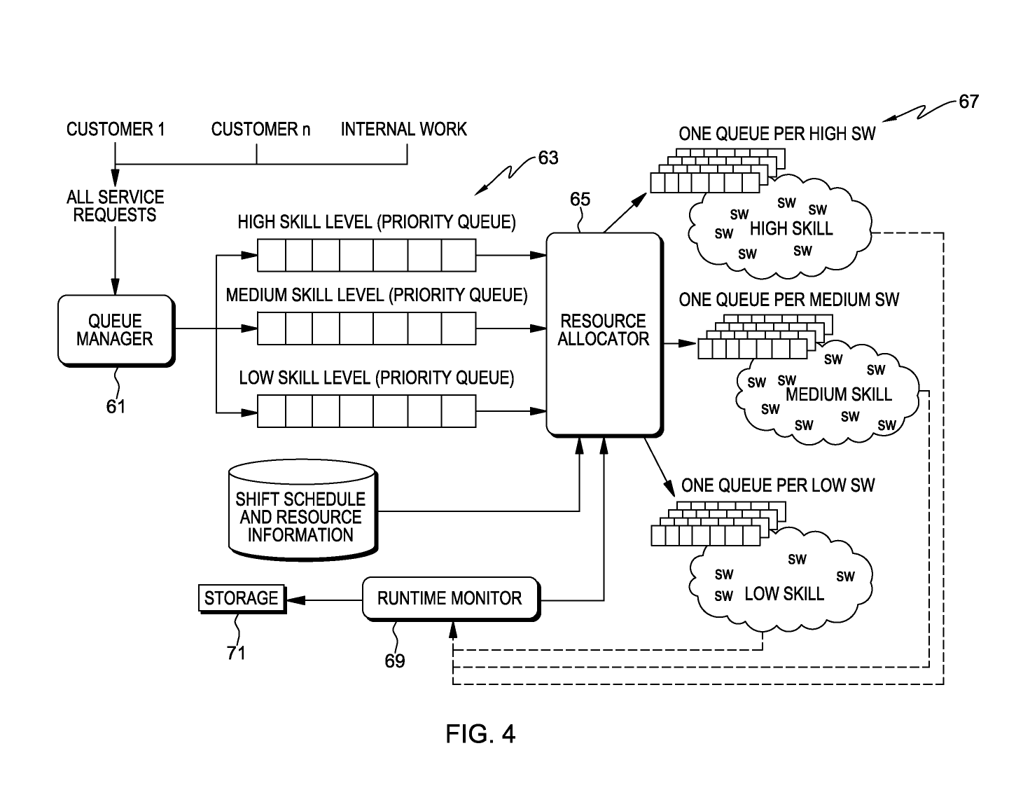

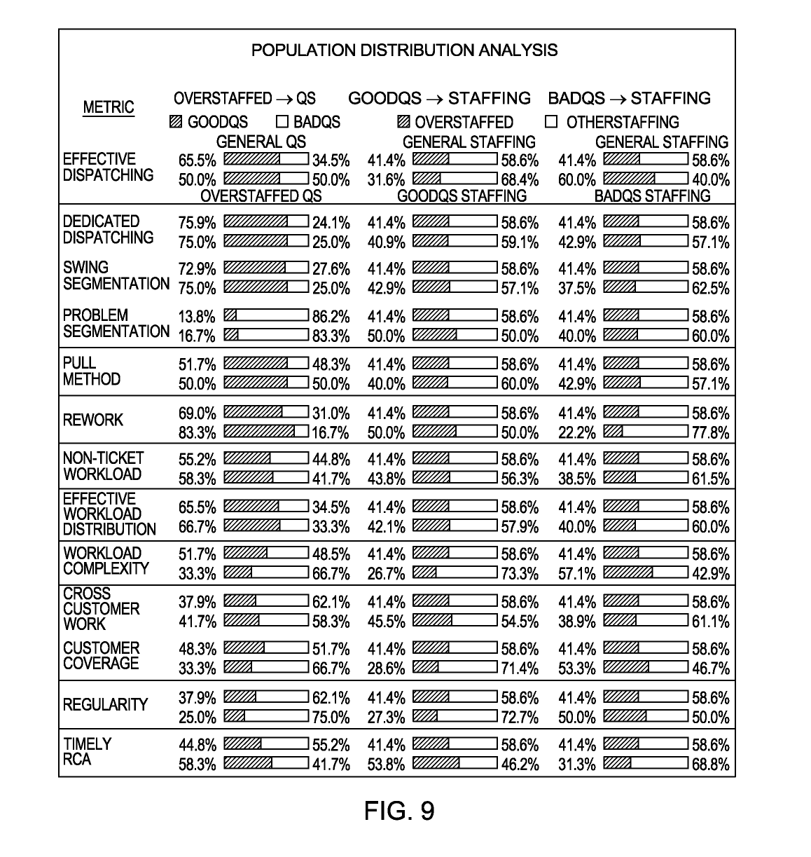

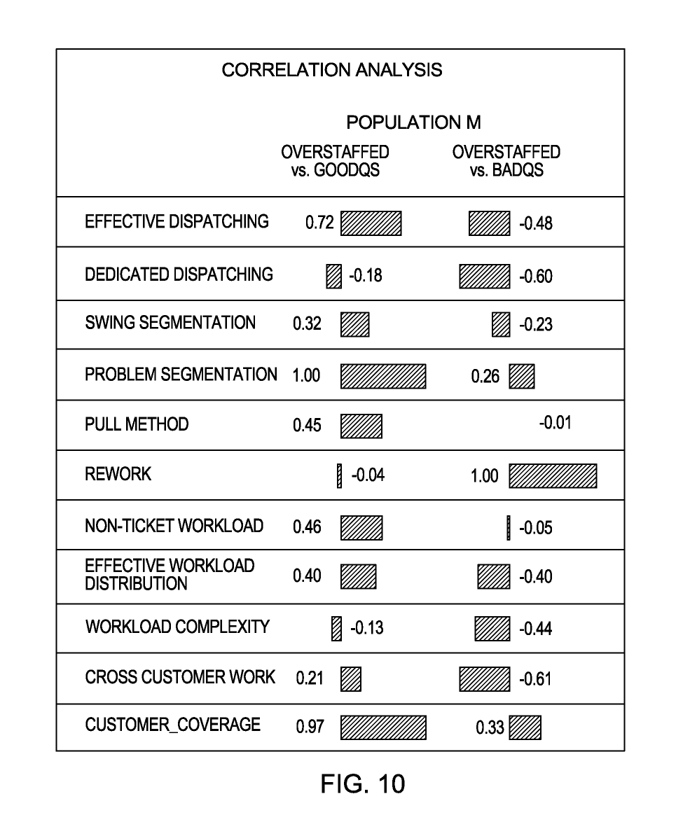

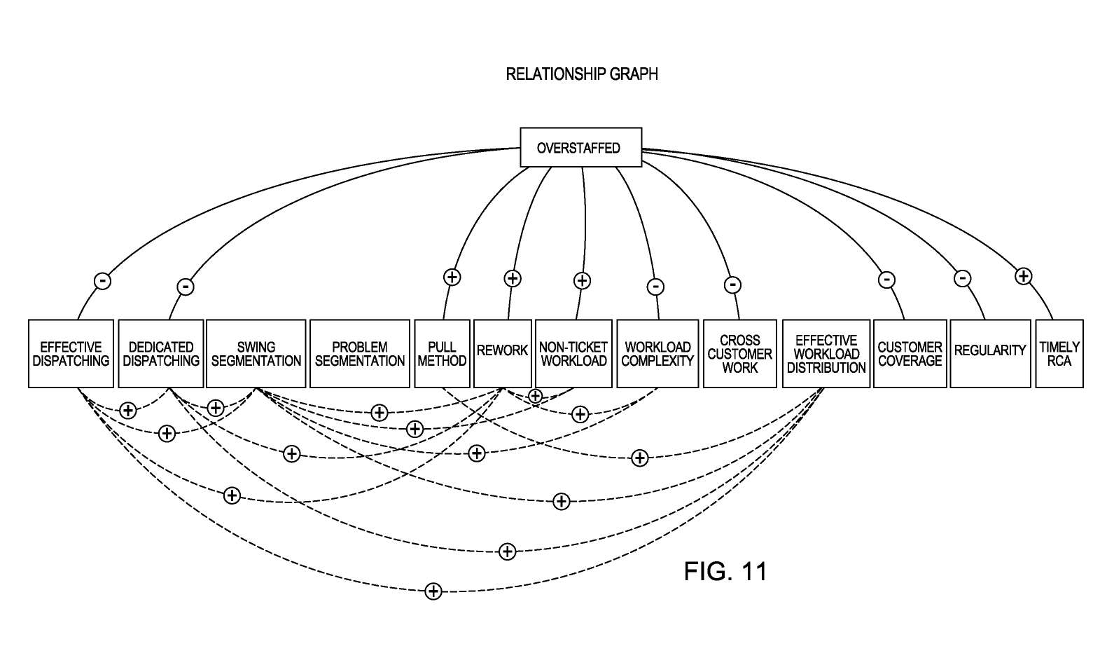

Again, with reference to FIG. 3, Workload Based SDS Simulation and Storage Module 43 is used to identify optimum or ideal staffing of an SDS based on workload. As used herein, the terms “effective”, “ideal”, “optimal”, or “optimum” staffing are used interchangeably but have the same meaning and represent staffing that minimizes the staffing level while satisfying the Service Level Agreement (SLA) constraints and the condition that the work queues (shown in FIG. 4) are not growing unbounded. The Operational Quality Measurement and Storage Module 45 is used to compute and understand the level of compliances of the operational performance of SDS's against ideal values or benchmarks set for selected metrics, as defined in the SDF components, to provide a quality score. Operational Quality to Staffing Relationship Analyzer Module 47 acts to capture and map the relationship between the quality score of each of the operational metrics with respect to staffing. This is done by computer analysis and integration of the relationship between the optimum staffing requirements computed by the Workload Based SDS Simulation Module 43 and stored in the storage of the Workload Based SDS Simulation and Storage Module 43 and the Quality Scores results computed and stored in the Operational Quality Measurement and Storage Module 45 to produce the Population Distribution Analysis, shown by way of example in FIG. 9. From these data, Correlation Analysis, as shown by way of example in the chart of FIG. 10, may be produced, as well as the Relationship Graph of FIG. 11.

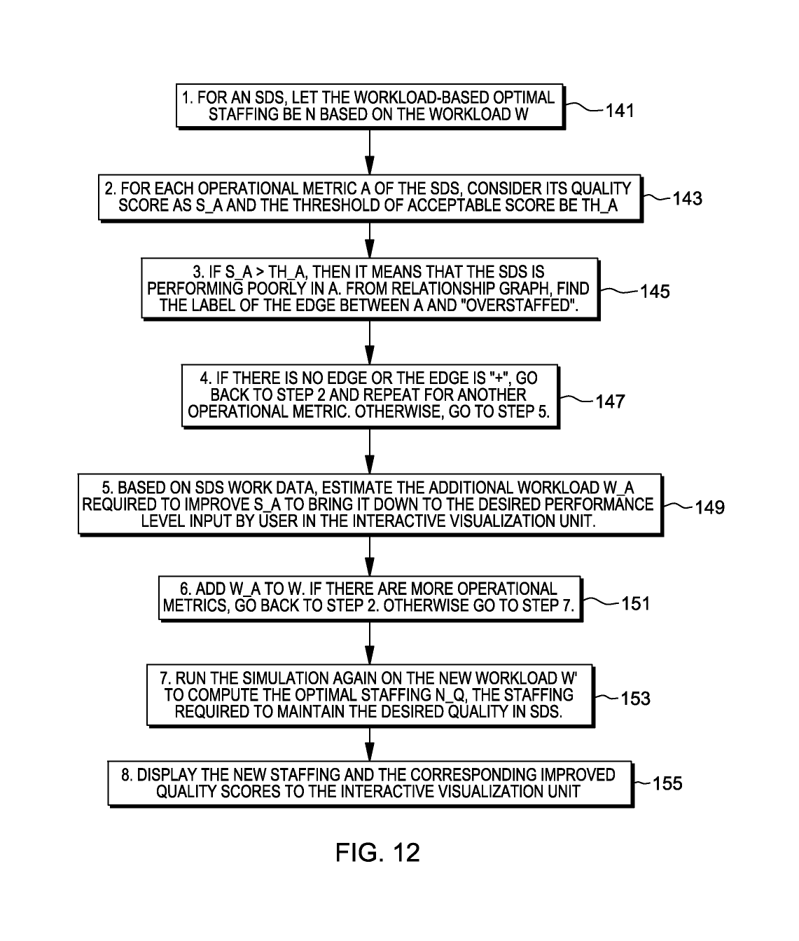

QS vs. Staffing Relationship Database 49 in FIG. 3 stores the quality score (QS) results of the Operational Quality to Staffing Relationship Analyzer Module 47. Operational Quality Aware Staffing SDS Recommender Module 51 operates to allow Operational Quality metrics stored in QS vs. Staffing Relationship Database to be used to determine new levels of Quality Aware Staffing corresponding to the levels of compliance of a given quality compliance rule. For example, a compliance rule requiring one (1) investigation be conducted every week for each customer in the SDS customer set may be investigated in a simulation using data in Database 49. The related Operational Quality Metric is customer coverage, as shown in FIG. 9. The SDS may support ten (10) customers. If the actual Operational Quality Score for this rule is, for example, 0.2 then Service Worker (SW) staffing can be selectively increased by 1, 3 or 8, for example, depending upon a theoretical level of compliance (30%, 50% or 100%). However, if the actual Service Time (ST) expended for these investigations, as taken from real data acquired by the SDS Simulation of Workload Based SDS Simulation component 43, is used, then SW and ST can be run in a simulation to arrive at new Quality Aware Staffing levels for the selected levels of quality compliance. By using the actual service time, this simulation may show that the actual increase in staffing to achieve 30%, 50% and 100% Quality Aware staffing N_Q is 9, 10 and 14, respectively. Thus, various parameters for determining Quality Aware staffing for the selected metrics using actual data from the QS vs. Staffing Database 49 may be interactively entered and adjusted for analysis via Interactive Visualization Unit 53. A process for carrying out the computation of results, such as given by this example, is shown in FIG. 12.

FIG. 4 shows the main units the Workload Based SDS Simulation Module 43 of FIG. 3. It should be noted that, as used herein, a “module” or “analyzer” may be software or firmware resident on computer processing hardware to perform the function of the module or special purpose hardware to perform the function of the module or a combination of both with the described function being one in which one skilled in the art could readily embody to carry out the function. Service Requests (SR) arrive from Customer sets 1 through n plus Internal Work. By way of example, within each hour of week Tj, and for Customer Ci, the arrivals follow a Poisson distribution with inter arrival averages given by α(Ci, Ty). The function α is learned from historical data of at least six (6) months of arrivals for each of the customers plus internal work.

As soon as a SR arrives, the Queue Manager 61 assigns it to the matching Skill Level Queue 63 based upon the priority Pc assigned by the customer or modified based upon factors, such as, shortest service time. Thus, the priority associated with SRs in the Skill Level Queues may be based on the customer assigned priority of the SR but may not be identical. The Skill Level Queues 63 are prioritized. Priority of SRs in the Skill Level Queues depends on the policy adopted. Resource Allocator 65 may act to push the SR to the best SW and queue it in the work queue of the SW or the SR may wait in the Skill Level Queue 63 until it reaches the head of the queue and a SW with a matching skill becomes available and pulls it. Typically, the latter is used where minimum skill level is required for a SR by assigning the SR to the appropriate individual skill level SW 67.

Thus, in the latter mode, the SRs move from the Skill Level Queues to individual SWs queues as soon as they are assigned by Resource Allocator to the SW. In general, the Resource Allocator controls when to dispatch a SR from the Skill Level queues 63 to an individual SW queues 67. A SW typically completes working on a SR and takes the next SR to work on from the head of their queue. The time taken by a SW to complete the work on a SR follows a Lognormal distribution with mean r₁ and standard deviation r₂. Distributions are computed for each skill level and each severity of work. The distribution function τ(P_{ids}X_{id}) is learned by conducting statistics where each SW records the actual “touch time” devoted to each of the SRs and P_{id} is the priority of the SR and X_{id} is the required skill level of the SR.

The Runtime Monitor 69 collects statistics on the performance of the SDS against the SLAs as well as other factors and statistics and stores them in Storage 71. It may also feedback the statistics to Resource Allocator 65. Among other statistics, the output of a simulation run is the actual SLA attainment percentages for each customer.

Optimum staffing levels are computed by conducting a search over the space of SDS Configurations. This is done by entering data into the Workload Based SDS Simulation Module 43 varying the set of SWs in the SDS, the shift staffing levels and skills of SWs as a map from a SW to the maximum skill level SR that the SW can support. The remainder of the SDS parameters are fixed. This results of the optimization is to create an ideal staffing level that minimizes the staffing level of SW while satisfying SLA conditions. Optimization is implemented as an interactive heuristic search.

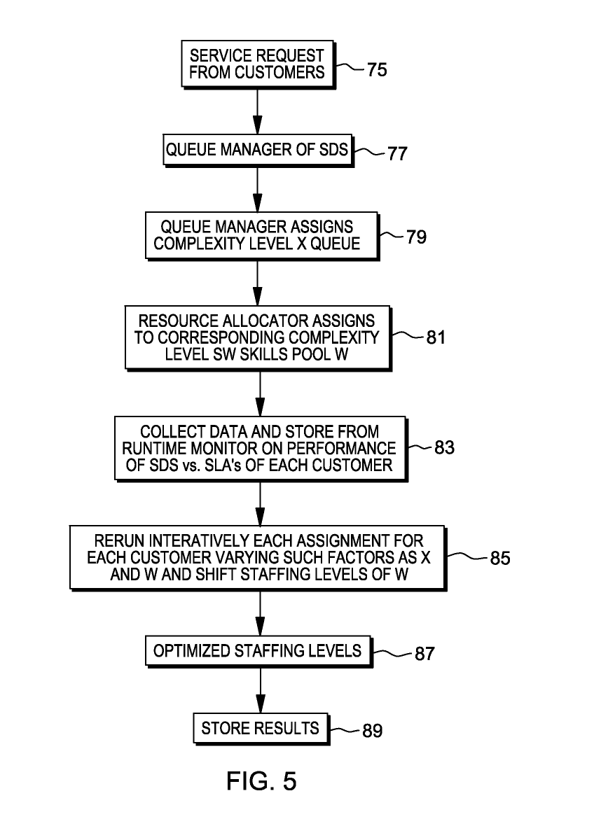

FIG. 5 shows flow chart of the process for optimizing staffing levels Service Requests (SR) are received at block 75 and sent to Queue Manager of the SDS 77. Queue Manager 77 assigns the SR to the appropriate X Skill Queue as shown at block 79. Resource Allocator 81 then assigns at block 79. Resource Allocator 81 then assigns the SR to the corresponding SW complexity Skill pool W.

The above process is iterative with SRs arriving from customers and internal work over a period of time, such as, six (6) months. The resulting data is collected by step shown at block 83 from a Runtime Monitor, such as Runtime Monitor 69 in FIG. 4. Among the data is the performance of the SDSs against Service Level Agreements (SLA) of each customer. The data collected by the step of block 83 is rerun iteratively at the step of block 85 varying the set W., shift staffing levels and skills X to the maximum complexity level of SRs that the SW is skilled to support. The results of those iterative reruns yield an optimum or ideal staffing level for each SDS as shown at block 87 and is stored at block 89, which storage corresponds to storage Workload Based SDS Simulation at module 43 in FIG. 3. The staffing output is sent to Operational Quality to Staffing Relationship Analyzer 47 and Operational Quality Aware Staffing Recommender 51.

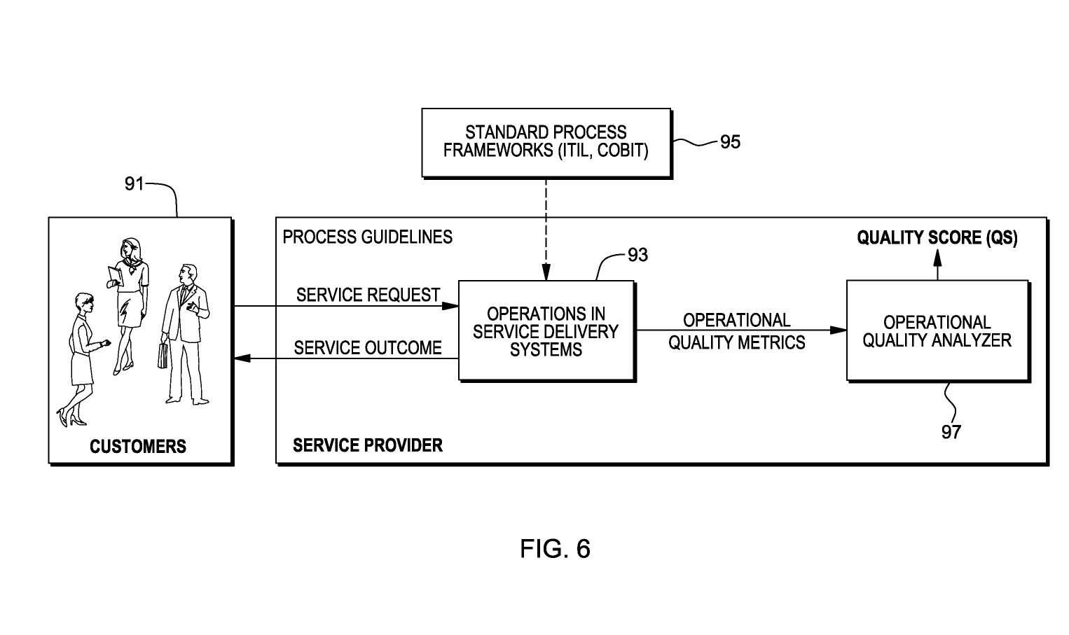

FIG. 6 shows a process/system view of one embodiment for determining Operational Quality and an Operational Quality Score for a service delivery system supporting multiple customers set as shown by block 91. A customer SR is sent to the Operations in the Service Delivery System (SDS) for operational service processing. The service processing is assigned a set of operational metrics for defining and measuring operational quality of the SDS. For better quality and continued improvements, the operations may be guided by standard processes, such as, ITIL or COBIT shown by module 95. Based upon the performance of a SDS in each of the predefined operational metrics, an aggregate Quality Score (QS) can be computed.

An example of an operational metric may be rework caused by incorrect assignment to SW decisions. This would thus be a way of measuring SR assignment quality.

The performance of SDS against a metric is periodically measured based upon a benchmark that provides boundary conditions for a metric that define an ideal state when performing best and a worst state when performing worst. Values are assigned between 0 (ideal) and 1 (worst). The measured value assigned to a metric is the QS. Similarly, a threshold may be assigned for each metric such that QS above the threshold for a metric is a bad QS and below the threshold is a good QS. The QS for a process may be a weighted average QS of its metrics.

Operational Quality Analyzer 97 takes the operational quality metrics as measured from the operations of the various Service Delivery Systems 93 and computes a QS for each SDS and each operational metric. The operational metrics are identified according to the service outcome of interest. An example of a set of Operational metrics is shown in the left hand Column of FIG. 9. It is clear that other metrics than those of this set may be used. For multiple SDSs, the operational quality metrics may be measured based upon raw operational data at fixed intervals of time, as taken over a substantial period of time SP. An aggregate QS for each metric is then computed at the end of the period SP.

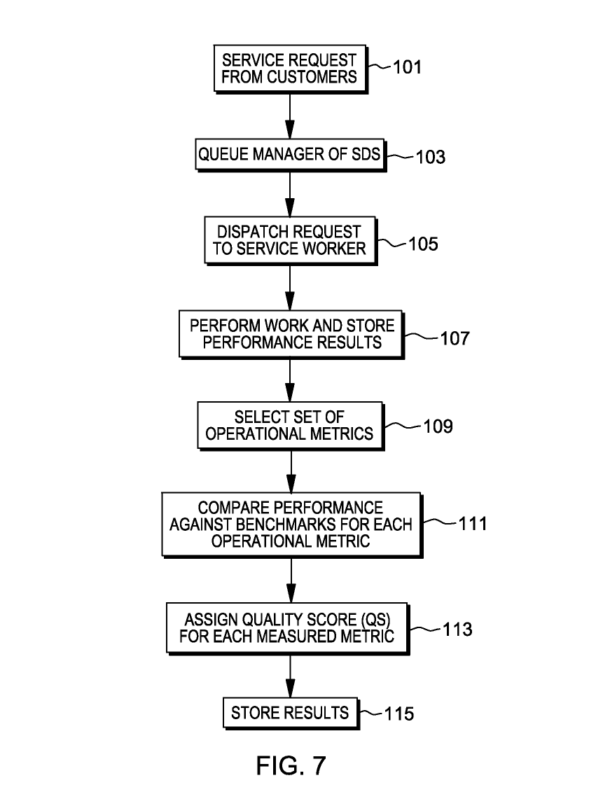

FIG. 7 shows a flow chart of the process for determining Operational Quality and a Quality Score. SRs are received at block 101 and sent to Queue Manager of the SDS at block 103 were it is assigned to a skill level queue. The SR is then dispatched by way of the Resource Allocator 65 in FIG. 4 or a dispatcher to a SW queue corresponding to the skill level. The SW performs the work as shown by block 107. Operational metrics, selected according to block 109, are then invoked to measure the corresponding operational aspects of the SW service performance. The measured results are compared against boundary conditions or benchmarks for each operational metric at the step of block 111 and a QS is computed for each metric at the step of block 113 and the results stored by the step of 115. The results are stored in Operational Quality Measurement module 45 in FIG. 3.

Again with reference to FIG. 3, the computed QS results for each SDS stored in Operational Quality Measurement and Storage Module 45 and the optimum staffing levels stored in Workload Based SDS simulation and Storage Module 43 are used as input to Operational Quality to Staffing Relationship Analyzer 47. The analyzer performs the task of mapping of various operational components defined by the operational metrics chosen for a selected outcome metric. The key SDS operational components that have the highest impact on selected outcome metric are identified and operational metrics with benchmarks defined and set.

An example of an outcome metric is labor costs which is measured by reduction in staffing requirements. To look at operational metrics measurements related to staffing, the following process is used by way of example for the set of metrics identified in FIG. 9. For a multiple SDS Population M, for a defined substantial period of weeks SP, each operational metric is measured based upon raw operational data every week. The average for each metrics for all weeks is then computed.

At the end of the same period, the optimal staffing requirements processed, as previously described, is used to compute the optimal staffing for the same SDSs. For each operational metric, the threshold is set as an average QS for the metric across the multiple SDSs. Thus, a Good QS for a SDS implies performing better than average and a Bad QS implies performing worse than average.

For the outcome metric of staffing requirements, Overstaffing is defined as the difference between actual current staffing and the optimal staffing of a SDS. A SDS is considered overstaffed if Overstaffing is positive, and other-staffed otherwise.

The results of the above outcome metric run are shown in FIG. 9 in the three columns to the right of the Metrics Column, with the operational metrics for this outcome metric shown in the left hand column. Benchmarks were defined for each operational quality metric. The resulting chart shows the likelihood for each operational metric with respect to staffing based upon the multiple SDSs. As a result of the low likelihood that a SDS is other-staffed, the overstaffed case is explored in the run. Each of the columns in the chart show the likelihood relevant for three types of relationships shown at the top. For each metric and a relationship, the top bar shows the general likelihood and the bottom bar shows the likelihood given the left-hand side of the relationship. For example, for effective dispatching and Bad QS→Overstaffed, the general likelihood of Overstaffed is 41.4% but the same given Bad QS is 60%.

FIG. 10 shows a Correlation Analysis using Pearson's correlation coefficients for operational quality metrics and staffing requirements. This is shown by way of an example of the use of the process/system in accordance with the invention. As an example of the correlation results, for the effective dispatching metric which may be handled by SDS automatically or by dispatcher, there is a negative correlation of −0.48 between the QS of Bad QS SDSs and the QS of Overstaffed SDSs implying the worse the dispatching, the lower the degree of Overstaffing.

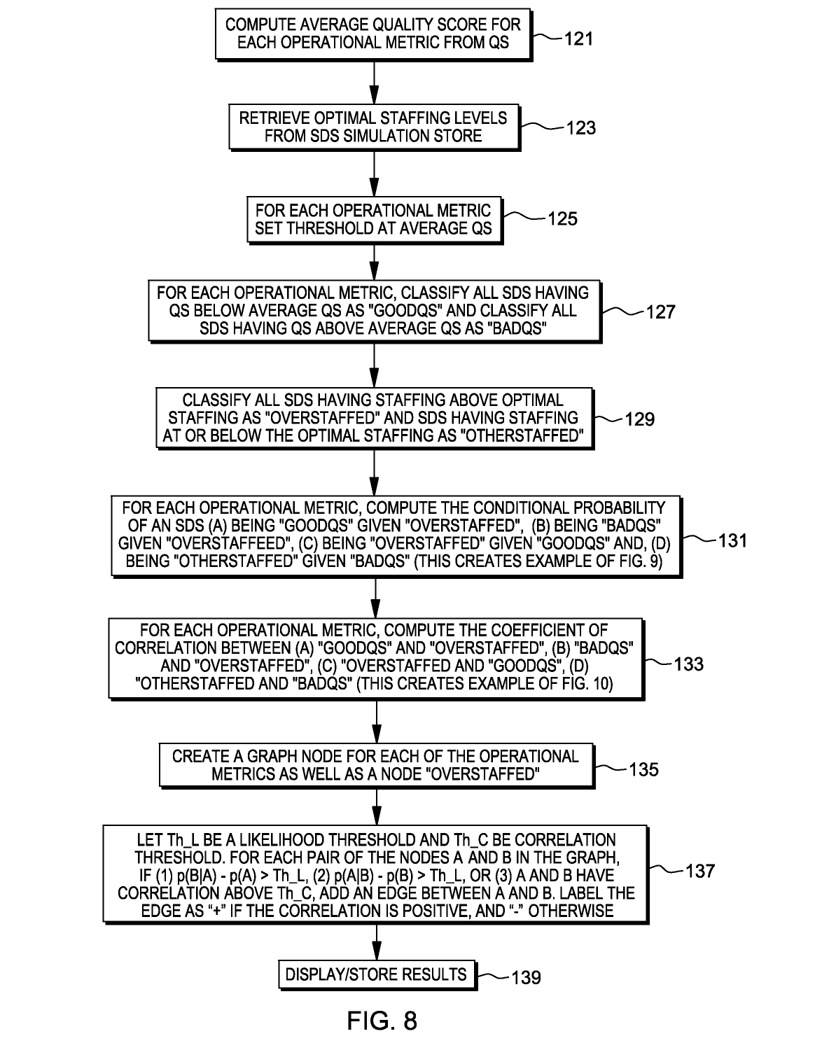

FIG. 8 shows a flow diagram for the operation of Operational Quality to staffing Relationship Analyzer 47 in FIG. 3. In the first step, shown by block 121, the average quality score for the Quality Scores QS for each operational metric across all SDS in the service delivery organization, is computed. The Quality Score QS is the output of the process shown by the flow chart of FIG. 7 which is stored by the step of block 115 in the storage of Operational Quality Measurement Module 45.

In the step shown by block 123, the optimal staffing levels from Workload Based SDS Simulation storage is retrieved. By the step of block 125, for each average operational metric Quality Score QS the threshold is set at the average QS. However, there are a variety of ways of computing the threshold of acceptable QS's. In the step of block 127, for each operational metric, all SDS's having a QS below the average are classified as “Good QS” and all SDS's having a QS above average are classified as a “Bad QS”.

In the step shown in block 129, all SDS's having staffing above the optimal staffing are classified as “Overstaffed” and all SDS's having staffing at or below the optimal staffing are classified as “Otherstaffed”. This step is followed by the step of block 131 wherein for each operational metric, the conditional probability of an SDS is computed as (a) being “Good QS” given “Overstaffed”, (b) being “Bad QS” given “Overstaffed”, (c) being “Overstaffed” given “Good QS” and (d) being “Otherstaffed” given “Bad QS”. An example of the output results of this computation is shown in the Population Distribution data chart of FIG. 9.

In the step of block 133, the coefficient of correlation between quality scores of all SDSs that are (a) “Good QS” and “Overstaffed”, (b) “Bad QS” and “Overstaffed”, (c) “Overstaffed” and “Good QS” and (d) “Otherstaffed” and “Bad QS” is computed. An example of the results of this computation is shown in the Correlation Analysis chart of FIG. 10.

In the step of block 135 of FIG. 8, a graph node is created for each of the operational metrics as well as a node “Overstaffed”. Then, in the step of block 137 “Th_L” is set as a likelihood threshold and “Th_C is set as a correlation threshold. For each pair of the nodes A and B in the graph, if (1) p(B/A)−p(A)>Th_L, (2) p(A/B)−p(B)>Th_L or (3) A and B have correlation above Th_C, add an edge between A and B. The edge is labeled as “+” if the correlation is positive, and “−” otherwise. An example of the results of this computation is the Relationship Graph shown in FIG. 12.

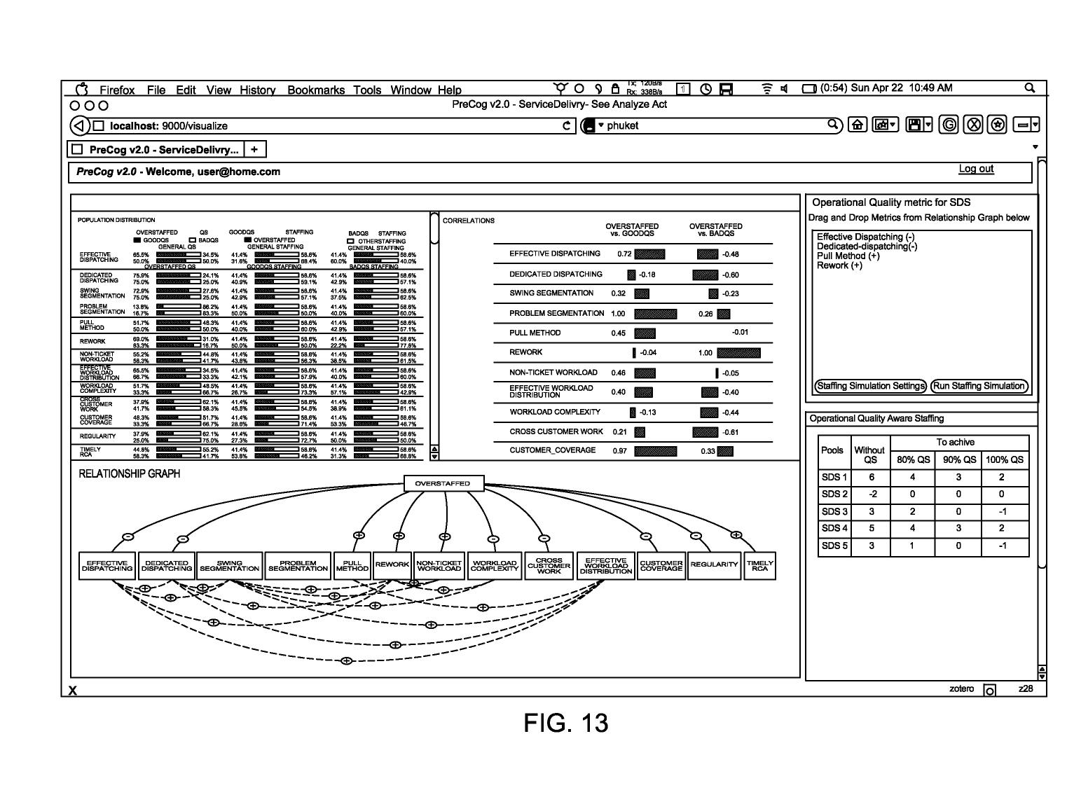

The results from the process of FIG. 8 may all be presented together in an interactive visualization display screen as shown in FIG. 13 which is an interface to the system of FIG. 3. In such an arrangement the user may interact to change metrics of an SDS by drag and drop to further set desired threshold values and run simulations to compute various staffing recommendations via Operational Quality Aware Staffing SDS Recommender module 51 in FIG. 3. One example of such staffing recommendations are those obtained by the computer simulation run to be described with respect to the process shown in Flow Chart of FIG. 12. In this example of a staffing the simulation is run with varying degrees of added work to show varying % levels of compliance for new Quality Aware Staffing for QS, as described earlier.

In another example, a simulations may be run for an “Overstaffed” condition where “overstaffed” is defined as Current staffing minus Optimal staffing. Because Optimal staffing increases with Higher QS, the “Overstaffed” quantity goes down. Thus, as shown in the “Operational Quality Aware Staffing Results” chart in the lower right hand corner of the interactive display screen of FIG. 13, Overstaffing decreases with increasing % QS.

The process shown by way of example in flow chart of FIG. 12 is carried out by Operational Quality Aware Staffing SDS Recommender 51 in FIG. 3. As shown in step #1 in FIG. 12, at block 141, “N” is set as the workload-based Optimal staffing of a SDS based upon workload “W”. In step #2 shown in block 143, for each operational metric “A”of the SDS, the quality score is set as “S_A” and the threshold of Acceptable score is “Th_A”. As shown in step #3 shown in block 145, if “S_A” is greater than “Th_A”, then it means that the SDS is performing poorly in “A”. From the relationship graph stored in Database 49, as shown by way of example in FIG. 11, the label of the edge between A and “Overstaffed” is retrieved. As set forth in step #4 shown in block 147, if there is no edge or the edge is “+”, the process returns to step #2 and is repeated for another operational metric. Otherwise the process moves to step #5.

In step #5, based upon actual stored SDS work data, the estimated additional workload “W_A” required to improve “S_A” to bring it down to the desired performance levels is provided. This may be a series of incremental estimations “W_A” selected by the user and stored in the system to be accessed and used in the simulation runs to give corresponding levels of Quality Aware staffing. The process continues in step #6 by adding the estimated additional workloads “W_A” to “W” to obtain “W”’. If there are more operational metrics, the process goes back to step #2. Otherwise, the process moves to step #7. In step #7, the simulation is run on the series of “W's” to compute the levels of Optimal Quality Aware staffing “N_Q” corresponding to the added “W_A's”. This may be displayed on the Interactive Visualization unit 53 in FIG. 13 as shown in step #8.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of the stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for determining operational quality aware staffing requirements in service delivery systems, comprising:
running a simulation over time of service delivery system service calls from multiple customers to determine performance results against the service level agreement and optimizing staffing levels while satisfying the service level agreement of the service delivery system;
periodically measuring operational quality metrics against benchmarks in the service delivery system as taken over multiple periods of time to determine quality scores based upon the level of operational performance of the service delivery system related to each metric of said operational quality metrics;
computing the threshold of acceptable quality score for each metric of the service delivery systems from the measurements taken in all service delivery systems;
setting quality scores above the threshold as one of either a good quality score or a bad quality score and quality scores below the threshold as the other;
computing overstaffing as the difference between the actual current staffing level and the optimal staffing level of a service delivery system so that when overstaffing is negative the service delivery system is other-staffed and needs more staffing and when overstaffing is positive the service delivery system has more staff than it needs; and
computing the likelihood for each average operational quality metric of said operational metrics with respect to staffing in a population distribution analysis.

2. The method for determining operational quality aware staffing requirements in a service delivery system as set forth in claim 1 wherein the likelihood is computed for an overstaffed or an other-staffed condition and good quality score or bad quality score condition.

3. The method for determining operational quality aware staffing requirements in a service delivery system as set forth in claim 2 wherein the step of periodically measuring operational quality metrics is conducted on multiple service delivery systems.

4. The method for determining operational quality aware staffing requirements in a service delivery system as set forth in claim 3 including the step of computing correlation coefficients for the operational quality metrics and staffing levels.

5. The method for determining an operational quality aware staffing requirements in a service delivery system as set forth in claim 3 wherein an operational quality metric is used in a simulation step in which staffing levels are varied in number and run against the actual average service call time for completing the service call work for the operational quality metric as input data to produce output data that relates staffing levels to the degree of compliance of the work to the quality metric.

6. The method for determining operational quality aware staffing requirements in a service delivery system as set forth in claim 1 wherein said step of optimizing staffing levels is carried out by running a simulation wherein the number of staff, shift staffing levels and skill sets are varied to find a minimum staffing level while satisfying said service level agreement.

7. The method for determining operational quality aware staffing requirements in a service delivery system as set forth in claim 1 wherein said likelihood data and correlation data is used to produce an operational quality staffing relationship map.

8. A computer program product for determining operational quality aware staffing requirements in service delivery systems, said computer program product comprising:
a computer readable storage medium;
first program instructions for running a simulation over time of service delivery system service calls from multiple customers to determine performance results against the service level agreement and optimizing staffing levels while satisfying the service level agreement of the service delivery system;
second program instructions for periodically measuring operational quality metrics against benchmarks in the service delivery system as taken over multiple periods of time to determine quality scores based upon the level of operational performance of the service delivery system related to each metric of said operational quality metrics;
third program instructions for computing the threshold of acceptable quality score for each metric of the service delivery systems from the measurements periodically taken over multiple periods of time;
fourth program instructions for setting the quality scores above the threshold as one of either a good quality score a bad quality score and quality scores below the threshold as the other;
fifth program instructions for computing overstaffing as the difference between the actual current staffing level and the optimal staffing level of a service delivery system so that when overstaffing is negative the service delivery system is other-staffed and needs additional staffing and when SI is positive the service delivery system has more staff than it needs;
sixth program instructions for computing the likelihood data for each average operational quality metric of said operational metrics with respect to staffing in a population distribution analysis; and
wherein said first, second, third, fourth, fifth and sixth program instructions are stored on said computer readable storage medium.

9. The computer program product for determining operational quality aware staffing requirements in a service delivery system as set forth in claim 8 wherein the likelihood data is computed for an overstaffed or other-staffed condition and good quality score or bad quality score condition.

10. The computer program product for determining operational quality aware staffing requirements in a service delivery system as set forth in claim 9 wherein said program instructions for periodically measuring operational quality metrics is conducted on multiple service delivery systems.

11. The computer program product for determining operational quality aware staffing requirements in a service delivery system as set forth in claim 10 wherein a step of correlation analysis computes correlation coefficients for the operational quality metrics and staffing levels.

12. The computer program product for determining an operational quality aware staffing requirements in a service delivery system as set forth in claim 10 wherein an operational quality metric is used in a simulation step in which staffing levels are varied in number and run against the actual average service call time for completing the service call work for the operational quality metric as input data to produce output data that relates staffing levels to the degree of compliance of the work to the quality metric.

13. The computer program product for determining operational quality aware staffing requirements in a service delivery system as set forth in claim 8 wherein said program instructions for step of optimizing staffing levels is carried out by running a simulation wherein the number of staff, shift staffing levels and skill sets are varied to find a minimum staffing level while satisfying said service level agreement.

14. The computer program product for determining operational quality aware staffing requirements in a service delivery system as set forth in claim 8 wherein said likelihood data or correlation data is used to produce an operational quality staffing relationship map.

15. A system for determining operational quality aware staffing requirements in service delivery systems, comprising:
a simulation module for running a simulation over time of service delivery system service calls from multiple customers to determine performance results against the service level agreement and optimizing staffing levels while satisfying the service level agreement of the service delivery system;
a measuring module periodically measuring operational quality metrics related to a service outcome of staffing against benchmarks in the service delivery system as taken over multiple periods of time to determine quality scores based upon the level of operational performance of the service delivery system related to each metric of said operational quality metrics;
an operational quality to staffing relationship analyzer for;
computing the acceptable threshold quality score for each metric of the service delivery system from the measurements periodically taken over multiple periods of time from multiple service delivery systems;
setting the quality scores above the threshold as one of either a good quality score or bad quality score and quality scores below the threshold as the other;
computing overstaffing as the difference between the actual current staffing level and the optimal staffing level of a service delivery system so that when overstaffing is negative the service delivery system is other-staffed and needs additional staff and when overstaffing is positive the service delivery system has more staff than needed; and
computing likelihood data for each average operational quality metric of said operational metrics with respect to staffing in a population distribution analysis.

16. The system for determining operational quality aware staffing requirements in a service delivery system as set forth in claim 15 wherein the likelihood data is computed for an overstaffed or other-staffed condition and for “Good QS” or “Bad QS” condition.

17. The system for determining operational quality aware staffing requirements in a service delivery system as set forth in claim 16 wherein the periodically measuring operational quality metrics is conducted on multiple service delivery systems.

18. The system for determining operational quality aware staffing requirements in a service delivery system as set forth in claim 17 wherein said operational quality to relationship analyzer performs a correlation analysis to compute correlation coefficients for operational quality metrics and staffing levels.

19. The system for determining an operational quality aware staffing requirements in a service delivery system as set forth in claim 17 wherein an operational quality metric is used in a simulation in which staffing levels are varied in number and run against the actual average service call time for completing the service call work for the operational quality metric as input data to produce output data that relates staffing levels to the degree of compliance of the work to the quality metric.

20. The system for determining operational quality aware staffing requirements in a service delivery system as set forth in claim 15 wherein said optimizing staffing levels is carried out by running a simulation wherein the number of staff, shift staffing levels and skill sets are varied to find a minimum staffing level while satisfying said service level agreement.
